(19) United States
(12) Patent Application Publication
(10) Pub. No.: US 2026/0144410 A1
(43) Pub. Date: May 28, 2026

(54) BATH PAD WITH COLOR CHANGE TEMPERATURE INDICATOR

(71) Applicant: UpAnAway, LLC, Greenfield, IN (US)

(72) Inventors: Smriti KHULLAR, Foster City, CA (US); Marie STILL, Pinellas Park, FL (US)

(21) Appl. No.: 19/391,341

(22) Filed: Nov. 17, 2025

Related U.S. Application Data
(60) Provisional application No. 63/723,734, filed on Nov. 22, 2024.

(51) Int. Cl. A47K 3/12; A47K 3/00; G01K 11/12

(52) U.S. Cl. CPC A47K 3/127; A47K 3/001; G01K 11/12

(57) ABSTRACT

A bath pad is provided that provides indication when exposed to temperatures that exceed a predetermined temperature.

### CROSS-REFERENCE TO RELATED APPLICATIONS

The present application claims priority under 35 U.S.C. § 119(e) to U.S. Provisional Application No. 63/723,734, titled “BATH PAD WITH COLOR CHANGE TEMPERATURE INDICATOR”, filed Nov. 22, 2024, the disclosure of which is hereby incorporated by reference in its entirety.

### FIELD OF THE DISCLOSURE

The present disclosure relates generally to bathing products for babies and, more particularly, to bathing pads utilizable for bathing newborns and infants.

### BACKGROUND OF THE DISCLOSURE

Bathing is one of the more difficult tasks for parents of infants and newborns. This is because there are many risks and difficulties associated with bathing for both the child and the parent, including slipping and falling, drowning, and the adult having to bend down constantly and handle a moving slippery child. The temperature of the water utilized in the bath is another risk that the parent needs to monitor. In particular, the parent needs to closely monitor the water temperature to ensure that it is not too hot or not too cold. Accordingly, methods and systems are desired for monitoring bath water temperature in order to help the parent ensure that their child is not exposed to unsafe bath conditions.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a bath pad includes a base, at least one petal connected to the base and extending outward from the base, a top side defined on the base and on the at least one petal, a bottom side defined on the base and on the at least one petal, and a temperature indicator arranged on the top side of the bath pad, wherein the temperature indicator changes color when exposed to temperatures above a predetermined temperature.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a top side of a bath pad with petals in an unattached configuration, in accordance with at least one aspect of the present disclosure.

FIG. 2 is a bottom side of the bath pad of FIG. 1, in accordance with at least one aspect of the present disclosure.

FIG. 3 is the bath pad of FIG. 1 with the petals in an attached configuration, in accordance with at least one aspect of the present disclosure.

FIG. 4 is a detailed view of a loop on the bottom side of the bath pad of FIG. 2, in accordance with at least one aspect of the present disclosure..

FIG. 5 is a detailed view of a pocket on the bottom side of the bath pad of FIG. 2, in accordance with at least one aspect of the present disclosure..

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to bath pads for young children and, more particularly, to bath pads that provide visual indication of water temperature so as to provide the parent/caregiver advanced warning if the bath pad is exposed to unsafe water temperatures. The embodiments disclosed herein include a bath pad having a base and at least one petal extending outward from the base so as to resemble a flower, such as a Lotus, wherein the bath pad further includes a temperature indicator. The temperature indicator is operable to change color when exposed to water temperatures at and above a predetermined temperature.

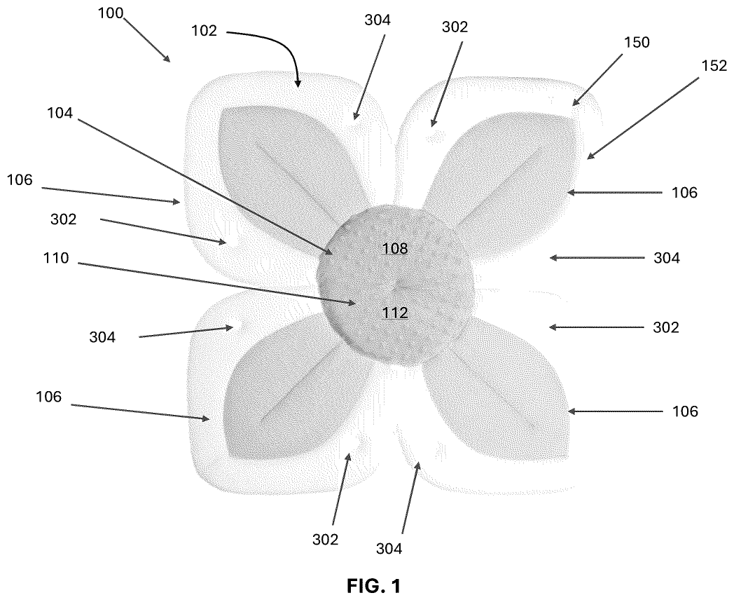

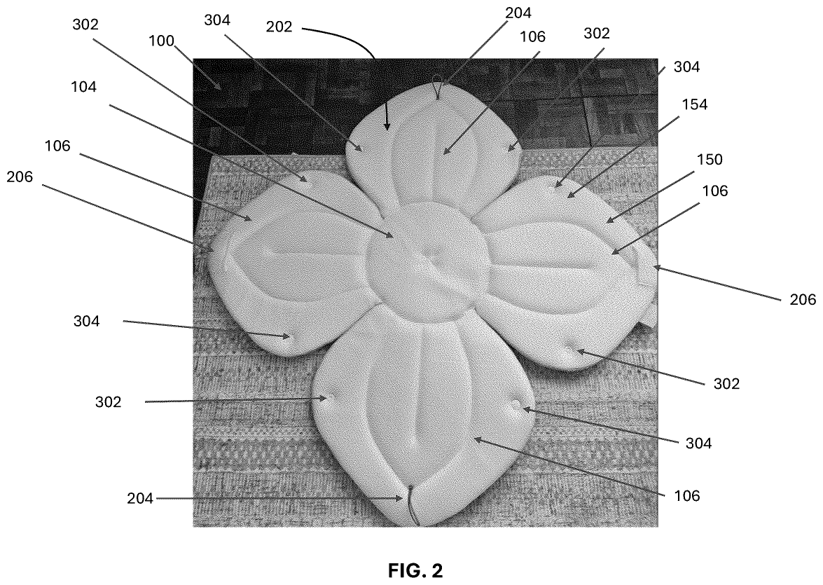

FIG. 1 is a top side 102 of a bath pad 100, in accordance with at least one aspect of the present disclosure. The bath pad 100 may include a base 104 and at least one petal 106 connected to the base 104 and extending outward from the base 104. While four petals 106 are shown, the bath pad 100 may have less than four petals 106 (e.g., two or three petals 106) or more than four petals 106 (e.g., five, six, or seven petals 106). The base 104 may represent a central seed pod of a flower from which the petals 106 extend. The base 104 may include, or otherwise provide, a textured surface 108 that includes raised features 110 (e.g., particles) that represent seeds of the central seed pod. The raised features 110 may provide traction to a child placed on the base 104. The bath pad 100, as illustrated, may be in the shape of, and/or have the appearance of, a Lotus flower. However, the bath pad 100 may alternatively be in the shape of, and/or have the appearance of, other types of flowers, such as a rose, a sunflower, or a daisy, as examples. FIG. 2 depicts a bottom side 202 of the bath pad 100, according to an embodiment.

With continued reference to FIG. 1, the bath pad 100 may include a temperature indicator 112 that may provide a visual cue to a user, such as a parent of a child, regarding the temperature of water in a bathtub. The temperature indicator 112 may be arranged on the top side 102 of the bath pad 100, such as on a top side of the base 104 or on a top side of one or more of the petals 106 or a combination thereof. In addition, or in the alternative, the temperature indicator 112 may be arranged on the bottom side 202, such as on a bottom side of the base 102 or on a bottom side of one or more of the petals 106 or a combination thereof.

The temperature indicator 112 may be a temperature sensitive dye that may be dyed (added) to a material of the base 104 and/or the petals 106. The temperature sensitive dye may be a pigment dye mixed with a thermo-chromatic adjuvant. The temperature sensitive dye may be a reversible thermochromic dye, such as Crystal Violet Lactone (CVL), Fluoran-based dyes, Spirooxazine derivatives, Spirolactone-type leuco dyes, or Phthalide-type dyes. The temperature sensitive dye may be a liquid crystal thermochromic material, such as Cholesteryl nonanoate, cholesteryl oleyl carbonate, cholesteryl benzoate, cholesteryl pelargonate, and/or cholesteryl chloride/ cholesteryl bromide mixtures. The temperature sensitive dye may be polymer-integrated thermochromic system, such as a Polydiacetylene (PDA), a Poly(N-isopropylacrylamide) (PNIPAAm) composite, and/or a Spiropyran-functionalized polymer. In the illustrated embodiment, the top side of the base 104 is made of a material which has been dyed with the temperature indicator 112.

The temperature indicator 112 may exhibit a particular color based on the temperature thereof. For instance, the temperature indicator 112 may exhibit a first or “default” color (e.g., orange or blue) when at or below, or subjected to a fluid (e.g., water) at or below, a predetermined temperature. The predetermined temperature may be about 100° F., but may alternatively be less than 100° F. (e.g., about 80° F., about 90° F., or about 95° F.) or greater than 100° F. (e.g., about 110° F., about 120° F., about 130° F.). In addition, the temperature indicator 112 may exhibit a second or “warning” color (e.g., yellow or purple) different than the first color when above, or subjected to a fluid (e.g., water) above, the predetermined temperature. The second color may be complementary to the first color such that the user may easily discern the difference between the first and second colors. For instance, the first color may be green, blue, or purple and the second color may be red, orange or yellow, respectively.

In an example use, the bath pad 100 may be placed in a basin (e.g., a sink or a bathtub) where a child will be bathed. The parent/caregiver may turn on the water which may be at a first temperature that is below the predetermined temperature. Based on the temperature indicator 112 being exposed or “getting wet” from the water, the temperature indicator 112 may exhibit the first (default) color, thereby providing a visual cue to the parent/caregiver that the temperature of the water is below the predetermined temperature and is, therefore, a suitable temperature for bathing the child. However, the temperature of the water may be inadvertently raised from the first temperature to a second temperature greater than the predetermined temperature. Based on the temperature indicator 112 being exposed or “getting wet” from the water at the second temperature, the temperature indicator 112 may transition from the first temperature to the second temperature, thereby providing a visual cue to the parent/caregiver than the temperature of the water is above the predetermined temperature and, thus, may be too hot for the child. Accordingly, the parent/caregiver may lower the temperature of the water until the temperature indicator 112 transitions to exhibiting the first color once again, thereby providing a visual cue that the water is now below the predetermined temperature.

The temperature indicator 112 may also be a temperature sensitive dye that exhibits more than two colors based on the temperature thereof. For instance, the temperature indicator 112 may exhibit a first or “cold” color when at or below, or subjected to a fluid (e.g., water) at or below, a first predetermined temperature, a second or “warm” color different than the first color when above, or subjected to a fluid (e.g., water) above, the first predetermined temperature, but at or below, or subjected to a fluid (e.g., water) at or below, a second predetermined temperature that is greater than the first predetermined temperature, and a third or “hot” color when above, or subjected to a fluid (e.g., water) above, the second predetermined temperature. Accordingly, the temperature indicator may provide a visual cue regarding if the water is “too cold” (i.e., exhibiting the first color), “just right” (i.e., exhibiting the second color), or “too hot” (i.e., exhibiting the third color). The first predetermined temperature may be about 85° F., but may alternatively be less than 85° F. (e.g., about 75° F., about 80° F., or about 82°F.) or greater than 85° F. (e.g., about 90° F., about 92° F., about 95° F.). The second predetermined temperature may be about 100° F., but may alternatively be less than 100° F. (e.g., about 80° F., about 90° F., or about 95° F.) or greater than 100° F. (e.g., about 110° F., about 120° F., about 130° F.).

The base 104 and the petals 106 may each comprise an outer layer 150 and a filling (occluded from view) provided (arranged) inside the outer layer 150. The filling may resist/prevent mold, mildew and/or odor. The outer layer 150 may be formed (constructed) from a polyester plush material and the filling may be a quick dry foam that is inserted into the polyester plus. The filling may be a polyurethane foam that holds (retains) water, retains warmth, and stays soft to the touch even when wet.

The filling may be cut to the shape of the base 104 and the petals 106 so as to provide rigidity to the same, thereby maintaining the desired flower shape, while also allowing bending and cushioning. The outer layer of the base 104 and the petals 106 may be stitched or otherwise secured around the filling. The outer layer of the base 104 and/or the petals 106 may have a resealable/closable opening through which the filling may be removed and reinserted, for example, to allow cleaning of the outer layer. The resealable/closable opening may include snaps, a zipper, a hook and loop fastener, or the like to allow the outer layer to be opened and closed.

The outer layer 150 may include a first outer layer portion 152 arranged on the top side 102 of the bath pad 100 and a second outer layer portion 154 arranged on the bottom side of the bath pad 100. The first and second outer layer portions 152, 154 may be the same material (e.g., polyester) or may be different materials. The first and second outer layer portions 152, 154 may have the same texture (e.g. plush or mesh) or may have different textures. For instance, the first outer layer portion 152 may be polyester plush and the second outer layer portion 154 may be a polyester mesh. The polyester mesh may provide traction within the basin. For instance, the polyester mesh may enable the bottom side 202 of the bath pad 100 to grip, or have traction with, a surface of a basin (e.g., sink or bathtub) within which it is placed during use.

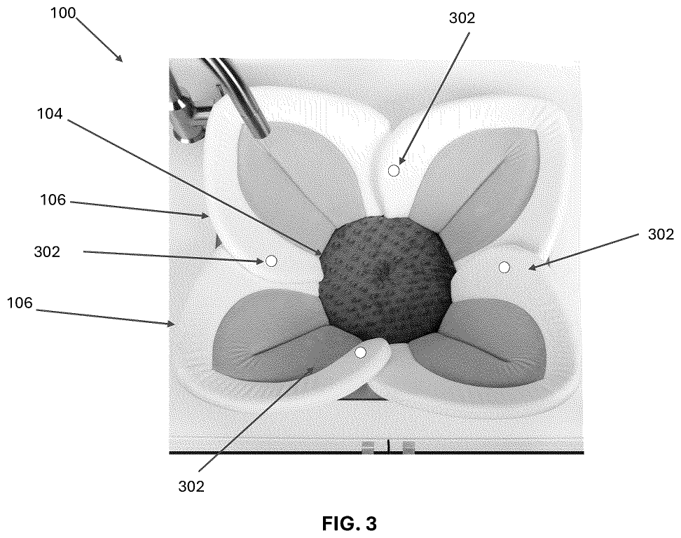

With reference to FIGS. 1-3, each petal 106 may include fasteners that allow the petal 106 to be selectively attached to adjacent petals 106, which may allow the bath pad 100 to exhibit a “cup-like” shape when placed into the basin. Attaching the petals 106 together may prevent, or substantially inhibit, portions of the basin from coming into direct contact with the child during use of the bath pad 100, such surfaces potentially being hard, unclean, and/or unsafe for young children. The fasteners may allow adjacent petals 106 to transition between a first or “unattached” configuration, as shown in FIGS. 1 and 2, and a second or “attached” configuration, as shown in FIG. 3. In the first configuration, the bath pad 100 may exhibit a first or “planar” shape and, in the second configuration, the bath pad 100 may exhibit a second or “cup” shape different than the first shape.

The fasteners may include a first fastener 302 arranged on a first lateral side of the petal 106 and a second fastener 304 arranged on a second lateral side of the petal 106 opposite the first lateral side. The first fastener 302 of a first petal 106 may be coupled to a second fastener 304 of an adjacent petal 106, thereby coupling the adjacent petals 106 together. The fasteners may be snap-button fasteners where the first fastener 302 is a first or “male” type snap-button fastener and the second fastener is a second or “female” type snap-button fastener that is configured to couple or “snap” to the first type snap-button fastener. Alternatively, the fasteners may be hook-and-loop type fasteners where the first fastener 302 is a hook type fastener and the second fastener is a loop fastener that is configured to couple to the hook fastener. The first fasteners 302 may be arranged to face the top side 102 of the bath pad 100 and the second fasteners 304 may be arranged to face the bottom side 102 of the bath pad 100. Accordingly, as shown in FIG. 3, adjacent petals 106 may overlap one another to couple the first and second fasteners 302, 304 to one another.

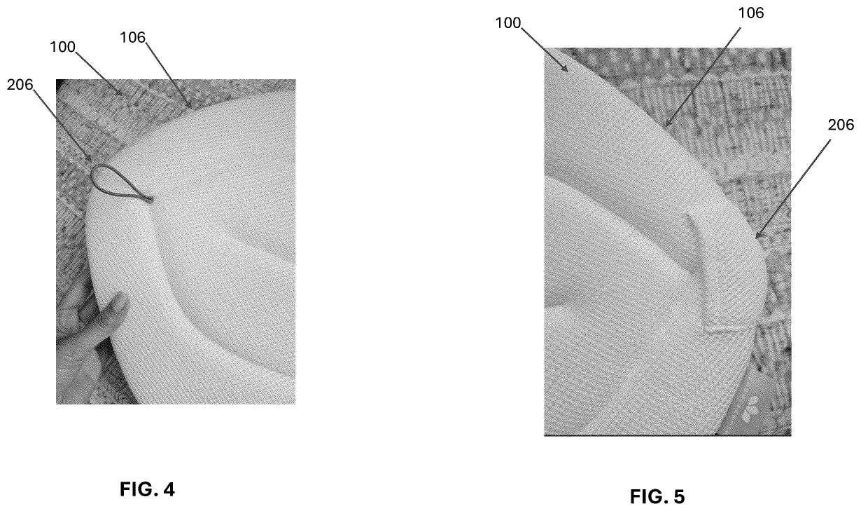

Referring again to FIG. 2, the bath pad 100 may have at least one loop 204 and at least one pocket 206. As illustrated, the bath pad 100 may include two loops 204 arranged on a first pair of opposing petals 106 and two pockets 206 arranged, or otherwise provided, or a second pair of opposing petals 106. FIG. 4 shows a close up of one of the loops 204 provided on one of the petals 106 and FIG. 5 shown a close up of one of the pockets 206 provide on one of the petals 106. The loops 204 may be attached to the bottom side of the petals 106, but they may also or instead be attached to the bottom side of the base 104. The pockets 206 may be attached to and formed on the bottom side of the petals 106, but they may also or instead be attached to or formed on the bottom side of the base 104. The loops 204 and/or the pockets 206 may allow the bath pad 100 to be hung on a wall, a door handle, or the like when the bath pad 100 is not in use, to allow the bath pad 100 to dry.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A bath pad, comprising:
a base;
at least one petal connected to the base and extending outward from the base;
a top side defined on the base and on the at least one petal;
a bottom side defined on the base and on the at least one petal; and
a temperature indicator arranged on the top side of the bath pad, wherein the temperature indicator changes color when exposed to temperatures above a predetermined temperature.

2. The bath pad of claim 1, wherein the predetermined temperature is 100 degrees Fahrenheit.

3. The bath pad of claim 1, wherein the temperature indicator comprises a temperature sensitive dye.

4. The bath pad of claim 1, wherein the temperature indicator is arranged only on the top side of the base.

5. The bath pad of claim 1, wherein the base and the at least one petal comprises polyester.

6. The bath pad of claim 5, wherein the polyester on the top side is a polyester plush and the polyester on the bottom side is a polyester mesh.

7. The bath pad of claim 6, wherein the base and the at least one petal further comprises polyurethane foam arranged inside of the base and the at least one petal.

8. The bath pad of claim 1, wherein the base and the at least one petal comprises a polyester layer and polyurethane foam arranged inside of the polyester layer.

9. The bath pad of claim 1, wherein the top side of the base comprises a textured surface.

10. The bath pad of claim 1, further comprising a fastener having a first part and a second part that are attachable together, wherein the at least one petal comprises a first petal and a second petal, the first part of the fastener is arranged on the first petal and the second part of the fastener is arranged on the second petal, and wherein the fastener connects the first and second petals together when the first part and the second part are attached together.

11. The bath pad of claim 9, wherein the fastener is a snap fastener or hook-and-loop fastener.

12. The bath pad of claim 1, wherein the at least one petal comprises four petals.

13. A bath pad, comprising:
a base; and
petals extending from the base;
wherein at least one of the base or the petal includes a temperature indicator transitionable between:
a first color indicative of the temperature indicator being a first temperature below a threshold temperature; and
a second color indicative of the temperature indicator being a second temperature above a threshold temperature.

14. The bath pad of claim 13, wherein the temperature indicator comprises a temperature sensitive dye.

15. The bath pad of claim 13, wherein the petals comprise:
a first petal including a first fastener; and
a second petal including a second fastener couplable to the first fastener.

16. The bath pad of claim 15, wherein the first and second fasteners are snap-button fasteners.

17. The bath pad of claim 13, wherein the petal includes a loop.

18. The bath pad of claim 13, wherein the petal provides a pocket.

19. The bath pad of claim 13, wherein the threshold temperature is a first threshold temperature and the temperature indicator is further transitionable to a third color indicative of the temperature indicator being a third temperature greater than a second temperature threshold that is greater than the first temperature threshold.
